(19) United States
(12) Patent Application Publication
(10) Pub. No.: US 2013/0229747 A1
(43) Pub. Date: Sep. 5, 2013

(54) BALANCED VOLTAGE VARIABLE CAPACITOR DEVICE

(71) Applicant: James P. Finnigan, Saratoga, CA (US)

(72) Inventor: James P. Finnigan, Saratoga, CA (US)

(73) Assignee: AGILENT TECHNOLOGIES, INC., Loveland, CO (US)

(21) Appl. No.: 13/409,526

(22) Filed: Mar. 1, 2012

(51) Int. Cl. H01G 5/38; H01G 5/06

(52) U.S. Cl. 361/299.1; 361/298.1

(57) ABSTRACT

A variable capacitor device includes a stator and a rotor. The stator includes first and second stator plates separated by electrically insulating material. The rotor includes first and second rotor plates connected by a rod, the rotor being configured to move axially for adjusting alignment of the first rotor plate relative to the first stator plate and the second rotor plate relative to the second stator plate, respectively. The first stator plate and the first rotor plate form a first variable capacitor, and the second stator plate and the second rotor plate form a second variable capacitor connected in series with the first variable capacitor. A first capacitance of the first variable capacitor and a second capacitance of the second variable capacitor are simultaneously adjustable upon the axial movement of the rotor to provide an adjustable total capacitance of the variable capacitor device.

### BACKGROUND

Variable capacitors may be used as capacitive tuning elements to adjust capacitance of a circuit. For example, capacitive tuning elements are used to make changes in the resonance frequencies of radio frequency (RF) resonators in nuclear magnetic resonance (NMR) spectrometers.

Generally, an NMR spectrometer includes a superconducting magnet for generating a static magnetic field and an NMR probe including special purpose RF coils for generating a time-varying magnetic field perpendicular to the static magnetic field, used to detect a response of a sample to the applied magnetic fields. Each RF coil and associated circuitry is able to resonate at a frequency of interest corresponding to a nucleus of interest present in the sample. In order to maximize accuracy of NMR measurements, the resonant frequency of each RF coil and associated circuitry is adjusted to equal the frequency of interest. Also, in order to maximize transfer of RF energy into the RF coils, impedance of each RF coil is matched to impedance of a transmission line and associated components used to couple RF energy into the RF coil. Thus, variable capacitors may be used to adjust the circuit resonant frequency equal the frequency of interest and/or to ensure optimal impedance matching. However, high voltages routinely applied to the variable capacitors in NMR spectrometers may lead to arcing to surrounding probe components and other undesirable effects.

A conventional variable capacitor generally includes one or more stator plates (electrodes) on a stator and corresponding one or more rotor plates (electrodes) on a rotor that moves in relation to the stator. The capacitance value of the variable capacitor is determined by the relative alignment of the stator plate(s) with the corresponding rotor(s), where the capacitance value generally increases with closer alignment. For example, a variable capacitor may include a rotor ring that rotates with respect to the stator, or a rotor piston that moves linearly with respect to the stator, to vary the relative alignment of the stator and rotor plates.

Solutions have been developed to improve voltage handling abilities of conventional variable capacitors, such as polishing the rotor piston and adding fluid to the variable capacitor. One example includes providing a unique stator shape with an extended dielectric, as described by Grossniklaus, et al., U.S. Pat. No. 7,394,642 (Jul. 1, 2008), which is hereby incorporated by reference. However, a fundamental problem remains that the variable capacitors are inherently unbalanced because they include a short or high capacitance connection at one end, such that capacitance is be varied essentially by changing the capacitance only an opposite end.

### SUMMARY

In a representative embodiment, a variable capacitor device includes a stator and a rotor. The stator includes a first stator plate and a second stator plate separated from the first stator plate by an electrically insulating material. The rotor includes a first rotor plate and a second rotor plate connected by a rod, the rotor being configured to move axially for adjusting alignment of the first rotor plate relative to the first stator plate and the second rotor plate relative to the second stator plate, respectively. The first stator plate and the first rotor plate form a first variable capacitor, and the second stator plate and the second rotor plate form a second variable capacitor connected in series with the first variable capacitor. A first capacitance of the first variable capacitor and a second capacitance of the second variable capacitor are simultaneously adjustable upon the axial movement of the rotor to provide an adjustable total capacitance of the variable capacitor device.

In another representative embodiment, a variable capacitor device includes a housing, a stator and a rotor. The housing is formed of a dielectric material and defines a bore. The stator includes first and second stator bands formed around an outer surface of the housing, the first and second stator bands being separated by a first separating portion of the dielectric material of the housing. The rotor includes first and second rotor plates, and a connector rod connecting the first and second rotor plates, where the rotor is configured to axially move within the bore of the housing between a maximum capacitance position, in which the first rotor plate is substantially aligned with the first stator band and the second rotor plate is substantially aligned with the second stator band, and a minimum capacitance position, in which the first rotor plate is substantially aligned with the first separating portion of the dielectric material.

In yet another representative embodiment, a capacitor device includes a first variable capacitor, a second variable capacitor, a connector rod and an actuator rod. The first variable capacitor includes first and second plates, the first plate being stationary and the second plate being movable with respect to the first plate to provide a variable first capacitance. The second variable capacitor includes third and fourth plates, the third plate being stationary and the fourth plate being movable with respect to the third plate to provide a variable second capacitance, the second variable capacitor being connected in series with the first variable capacitor. The connector rod is configured to connect the second and third plates at a fixed distance, and the actuator rod is configured to move the second and fourth plates simultaneously. A total capacitance of the capacitor device includes a product of the first and second capacitances divided by a sum of the first and second capacitances, and a voltage applied across the capacitor device is divided between the first and second variable capacitors.

### BRIEF DESCRIPTION OF THE DRAWINGS

The illustrative embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIGS. 1A and 1B are simplified block diagrams illustrating a variable capacitor, and FIG. 1C is a corresponding simplified circuit diagram, according to a representative embodiment.

FIGS. 2A and 2B are simplified cross-sectional diagrams illustrating a variable capacitor, according to a representative embodiment.

FIGS. 3A and 3B are simplified block diagrams, and FIG. 3C is a corresponding simplified circuit diagram, illustrating a conventional variable capacitor.

FIG. 4 is a graph showing increases in withstanding voltage versus total capacitance of a variable capacitor device, according to a representative embodiment.

### DETAILED DESCRIPTION

In the following detailed description, for purposes of explanation and not limitation, illustrative embodiments disclosing specific details are set forth in order to provide a thorough understanding of embodiments according to the present teachings. However, it will be apparent to one having had the benefit of the present disclosure that other embodiments according to the present teachings that depart from the specific details disclosed herein remain within the scope of the appended claims. Moreover, descriptions of well-known devices and methods may be omitted so as not to obscure the description of the example embodiments. Such methods and devices are within the scope of the present teachings.

Generally, the various embodiments provide a variable capacitor device that includes a stator and a rotor that is movable in relation to the stator. The stator includes at least two stator plates and the rotor includes corresponding at least two rotor plates paired with the at least two stator plates, respectively. A first pair of stator and rotor plates provides a first variable capacitor and a second pair of stator and rotor plates provides a second variable capacitor, where corresponding first and second capacitances from the rotor to the stator are connected in series. The first and second capacitances vary together as the rotor moves in relation to the stator, providing a variable combined or total capacitance, where the voltage across the variable capacitor device is balanced, that is, split between the first and second variable capacitors. The variable capacitor device provides a total maximum capacitance value when the first and second pairs of stator and rotor plates are substantially aligned with one another (e.g., as close to complete overlap as the configuration allows), and a total minimum capacitance value when the first and second pairs of stator and rotor plates are substantially unaligned (e.g., as close to no overlap the configuration allows). In various embodiments, the variable capacitor device also provides any total capacitance value between when the minimum and maximum capacitance values as the rotor is moved to various positions between the minimum (substantially unaligned) and maximum (substantially aligned) positions.

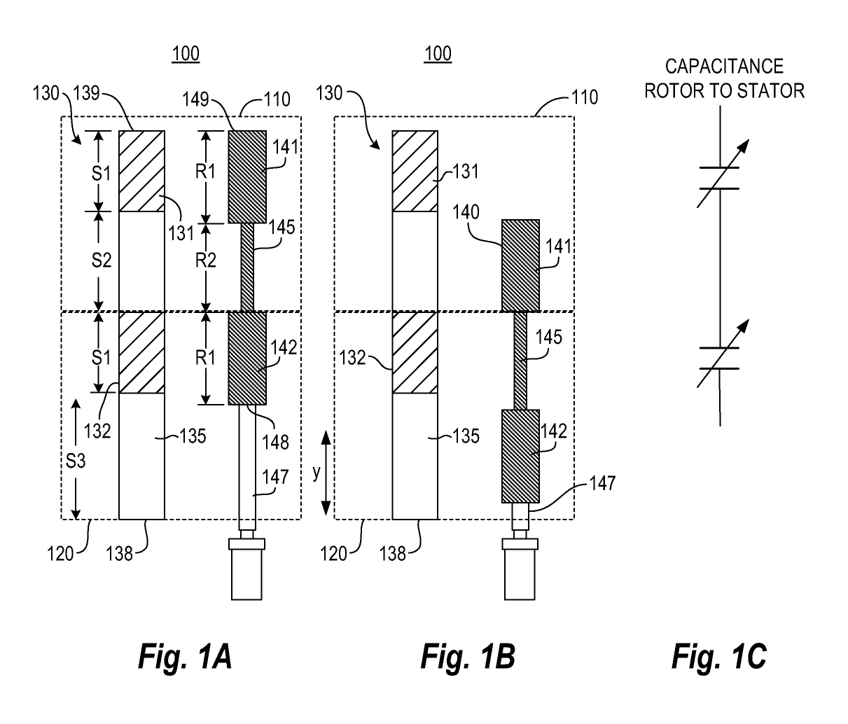

FIGS. 1A and 1B are simplified block diagrams illustrating a variable capacitor device, and FIG. 1C is a corresponding simplified circuit diagram, according to a representative embodiment.

Referring to FIGS. 1A and 1B, variable capacitor device 100 includes first variable capacitor 110 and second variable capacitor 120. The first and second variable capacitors 110 and 120 are electrically connected in series with one another, as indicated by FIG. 1C. The first variable capacitor includes first plate 131 and second plate 141, where the first plate 131 is stationary and the second plate 141 is movable relative to the first plate 131. The relative positioning of the first and second plates 131 and 141 provide a variable first capacitance. For example, the first capacitance is at its maximum value when the first and second plates 131 and 141 are substantially aligned with one another (e.g., as shown in FIG. 1A), and the first capacitance is at its minimum value when the first and second plates 131 and 141 are substantially unaligned with one another (e.g., as shown in FIG. 1B). The value of the first capacitance varies along a continuum between the maximum and minimum values according to the relative position of the second plate 141 between the aligned and unaligned positions.

The second variable capacitor 120 similarly includes third plate 132 and fourth plate 142, where the third plate 132 is stationary and the fourth plate 142 is movable relative to the third plate 132. The relative positioning of the third and fourth plates 132 and 142 provide a variable second capacitance. For example, the second capacitance is at its maximum value when the third and fourth plates 132 and 142 are substantially aligned with one another (e.g., as shown in FIG. 1A), and the second capacitance is at its minimum value when the third and fourth plates 132 and 142 are substantially unaligned with one another (e.g., as shown in FIG. 1B). The value of the second capacitance varies along a continuum between maximum and minimum values according to the relative position of the fourth plate 142 between the aligned and unaligned positions.

The total capacitance of the variable capacitor device 100 is effectively the product of the first and second capacitances divided by the sum of the first and second capacitances. That is, the total capacitance across both the first and second variable capacitors 110 and 120 may be calculated using the formula for adding capacitors in series: 1/C₁₁₀+1/C₁₂₀=1/Cₜₒₜₐₗ, where C₁₁₀ is the first capacitance, C₁₂₀ is the second capacitance, and Cₜₒₜₐₗ is the total capacitance.

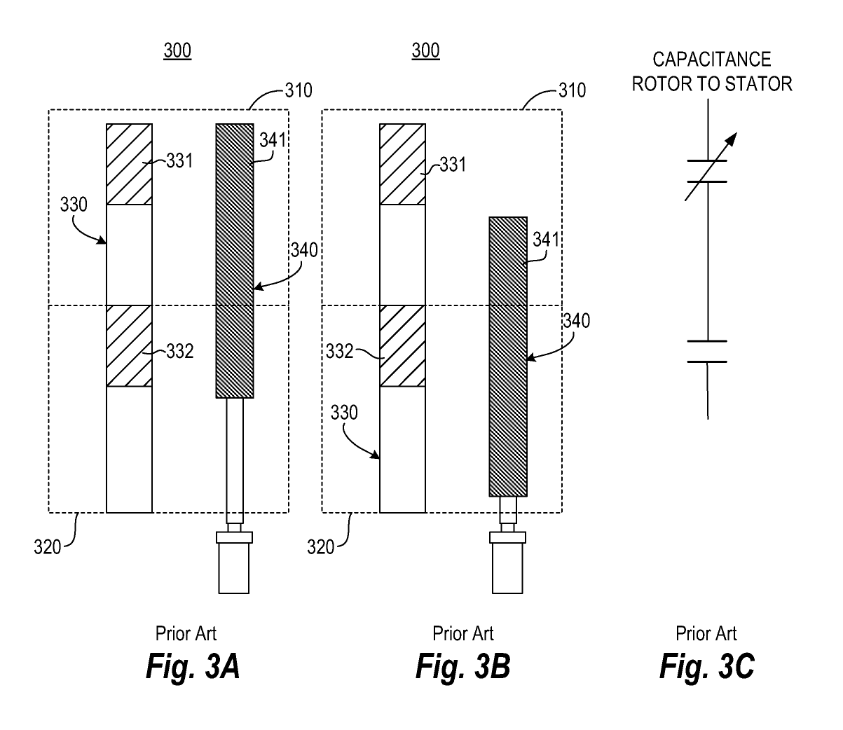

Also, voltage is balanced or spread out across the variable capacitor device 100, as opposed to being across only one of the first variable capacitor 110 or the second variable capacitor 120. For example, when the first and second variable capacitors 110 and 120 are the same size, each of the first and second variable capacitors 110 and 120 supports about half of the total voltage across the variable capacitor device 100. Thus, as compared to conventional capacitor devices in which only one set of variable capacitors plates (e.g., first and second plates 331 and 341 in FIGS. 3A and 3B) supports most of the capacitor voltage, the depicted embodiment effectively cuts the voltage in half for each of the first and second variable capacitors 110 and 120. This enables use of smaller capacitors and significantly reduces arcing, for example.

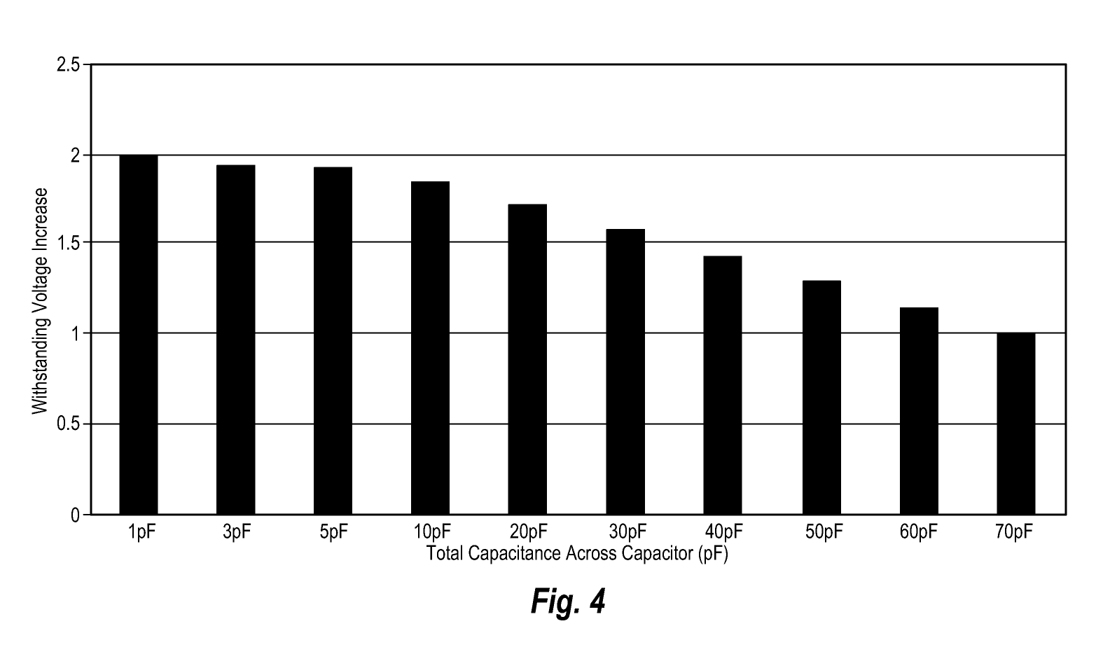

FIG. 4 is a graph showing increases in withstanding voltage versus total capacitance of a variable capacitor device according to a representative embodiment.

Referring to FIG. 4, the total capacitance of the first and second variable capacitors (e.g., first and second variable capacitors 110 and 120) is varied from 1 ρF to 70 ρF. The withstanding voltage of the capacitor device (e.g., variable capacitor device 100) is measured at each of the total capacitances indicated, and compared with corresponding withstanding voltages of a conventional capacitor device (e.g., capacitor device 300) at the same total capacitance. FIG. 4 shows the increase in the withstanding voltage at each total capacitance. For example, the withstanding voltage of the variable capacitor device according to a representative embodiment is doubled at 1 ρF in comparison to the conventional variable capacitor device. As the total capacitance increases from 1 ρF, the difference in withstanding voltage decreases, as indicated by the withstanding voltages corresponding to 3 ρF through 70 ρF, until reaching the maximum capacitance, at which the withstanding voltages of the capacitors are the same. This trend in behavior is optimal since the withstanding voltage of a capacitor increases with capacitance anyway. Therefore, arcing becomes less of a problem at higher capacitances. Stated differently, Z=1/jwC impedance decreases as capacitance increases.

Referring again to FIGS. 1A and 1B, in the depicted embodiment, the stationary first and third plates 131 and 132 may be formed on a stator 130, and the movable second and fourth plates 141 and 142 may be formed on a rotor 140. Each of the stationary first and third plates 131, 132 and the movable second and fourth plates 141, 142 are formed of electrically conductive material, such as metal or metal alloy. For example, each of the stationary first and third plates 131, 132 and the dynamic second and fourth plates 141, 142 may be formed of one or more of molybdenum (Mo), tungsten (W), copper (Cu), aluminum (Al), gold (Au), or the like.

The stator 130 includes substrate 135, which may be formed of an electrically insulating material, such as plastic (e.g., polytetrafluoroethylene or Teflon®), glass, ceramic, sapphire, quartz, or other dielectric material, for example. The stator 130 has a proximal end 138 and a distal end 139 in relation to an actuator (not shown), discussed below with reference to the rotor 140. The stationary first plate 131 is formed on the surface of the substrate 135 at or near the distal end 139, and the stationary third plate 132 is formed on the surface of the substrate 135 between the stationary first plate 131 and the proximal end 138. In the depicted embodiment, the stationary first and third plates 131 and 132 each has a length S1, and are separated from one another by a first separating portion of the substrate 135 having a length S2. The stationary third plate 132 is separated from the proximal end 138 by a second separating portion of the substrate 135 having a length S3. However, the relative sizes (e.g., including lengths S1, S2, S3) may be varied to provide unique benefits for any particular situation or to meet application specific requirements of various implementations. For example, the stationary first and third plates 131 and 132 may have different lengths, respectively, indicating different size first and second variable capacitors 110 and 120, without departing from the scope of the present teachings.

The rotor 140 includes a connector rod 145 and an actuator rod 147. The connector rod 145 electrically and mechanically connects the movable second and fourth plates 141 and 142 to one another. The connector rod 145 is formed of an electrically conductive material, and may be the same or different material as the second and fourth plates 141 and 142. The actuator rod 147 is connected to the movable fourth plate 142 at an end opposite that to which the connector rod 145 is connected. The actuator rod 147 is formed of an electrically insulating material, such as ceramic, ultem, fiberglass, quartz, or other dielectric material, for example.

The actuator rod 147 connects the rotor 140 to an actuator (not shown). The actuator may be any device capable of moving the rotor 140 in an axial direction (indicated by “y”), such as a screw actuator, for example. The actuator may be controlled by a microcontroller or other processing device, for example, in order to adjust the rotor 140 (via the actuator rod 147) to the appropriate position to provide the desired total capacitance, although other means of operating the actuator rod 147 and/or controlling the actuator may be incorporated without departing from the scope of the present teachings. In various embodiments, when a processing device is used, it may be implemented by a processor, application specific integrated circuits (ASICs), field-programmable gate arrays (FPGAs), or combinations thereof, using software, firmware, hard-wired logic circuits, or combinations thereof. When using a processor, a memory is included for storing executable software/firmware and/or executable code that allows it to perform the various functions. The memory may be any number, type and combination of nonvolatile read only memory (ROM) and volatile random access memory (RAM). Further, the memory may include any number, type and combination of tangible computer readable storage media, such as disk drive, electrically programmable read-only memory (EPROM), electrically erasable and programmable read only memory (EEPROM), a CD, a DVD, a universal serial bus (USB) drive, and the like.

Similar to the stator 130, the rotor 140 has a proximal end 148 and a distal end 149 in relation to the actuator, where the proximal end 148 moves closer to or further from the actuator (via the actuator rod 147). That is, operation of the actuator moves the rotor 140 in the axial direction to a position corresponding to a desired capacitance by simultaneously adjusting the respective alignments of the stationary first plate 131 and the movable second plate 141 of the first variable capacitor 110, and the stationary third plate 132 and the movable fourth plate 142 of the second variable capacitor 120, as discussed above. In the depicted embodiment, the rotor 140 is “floating,” meaning that the rotor 140 is not electrically conductive to the stator 130.

The movable second and fourth plates 141 and 142 each has a length R1, and are separated from one another by the fixed length of the connector rod 145 having a length R2. In the depicted embodiment, the length R1 is substantially the same as the length S1, and the length R2 is substantially the same as the length R2. In this configuration, the first and second variable capacitors 110 and 120 are about the same size, and the corresponding first and second variable capacitances are about equal for any particular position of the rotor 140 relative to the stator 130. However, the relative sizes (e.g., including lengths R1, R2) may be varied to provide unique benefits for any particular situation or to meet application specific requirements of various implementations. For example, the movable second and fourth plates 141 and 142 may have different lengths, respectively, indicating different size first and second variable capacitors 110 and 120, without departing from the scope of the present teachings.

As mentioned above, the total capacitance of the variable capacitor device 100 is effectively the total capacitance is the product of the first and second capacitances divided by the sum of the first and second capacitances. Also, voltage applied across the variable capacitor device 100 is divided between the first variable capacitor 110 and the second variable capacitor 120. That is, the voltage is split, or shared by each end of the variable capacitor device 100. Accordingly, the variable capacitor device 100 is able to handle up to about twice the voltage at low capacitance values of a conventional variable capacitor device 100 with the same total capacitance.

The connector rod 145 has a narrower width (or diameter) than each of the movable second and fourth plates 141 and 142. For example, the connector rod 145 may be between about 50% and about 80% narrower than the movable second and fourth plates 141 and 142. Accordingly, the connector rod 145 has minimal to no effect on the value of the variable second capacitance, for example, when all or a portion of the connector rod 145 is partially or substantially aligned with the stationary third plate 132 of the stator 130. The ability of the present embodiment to simultaneously vary the first and second capacitances of the first variable capacitor 110 and the second variable capacitor 120, respectively, enables the variable capacitor device 100 to have a higher withstanding voltage and lower minimum capacitance.

This differs from a conventional variable capacitor device, in which the rotor has a constant width or diameter, such that movement of the rotor relative to a stator plate does not alter capacitance of a second capacitor. For example, FIGS. 3A and 3B are simplified block diagrams illustrating a conventional variable capacitor device. In particular, variable capacitor device 300 includes variable capacitor 310 and fixed capacitor 320, which are electrically connected in series with one another, as indicated by the simplified circuit diagram shown in FIG. 3C.

The first variable capacitor includes first and third plates 331 and 332 on stator 330, as well as second plate 341 on rotor 340, where the first and third plates 331 and 332 are stationary and the second plate 341 is movable relative to the stationary first and third plates 331 and 332. The relative positioning of the first and second plates 331 and 341 provide a variable first capacitance and the positioning of the third and second plates 332 and 341 provide a fixed second capacitance.

For example, the first capacitance is at its maximum value when all of the first plate 331 is aligned with the a portion of the second plate 341 (e.g., as shown in FIG. 3A), and the first capacitance is at its minimum value when the first plate 331 is not aligned with any portion of the second plate 341 (e.g., as shown in FIG. 3B). Meanwhile, the second capacitance remains essentially constant because of the uniform size of the second plate 341, regardless of the relative positioning. Therefore, using the conventional variable capacitor device 300, the entire range of the total variable capacitance must be covered by the variable capacitor 310. The fixed capacitor 320 is always set to maximum capacitance and therefore always supports the minimum voltage.

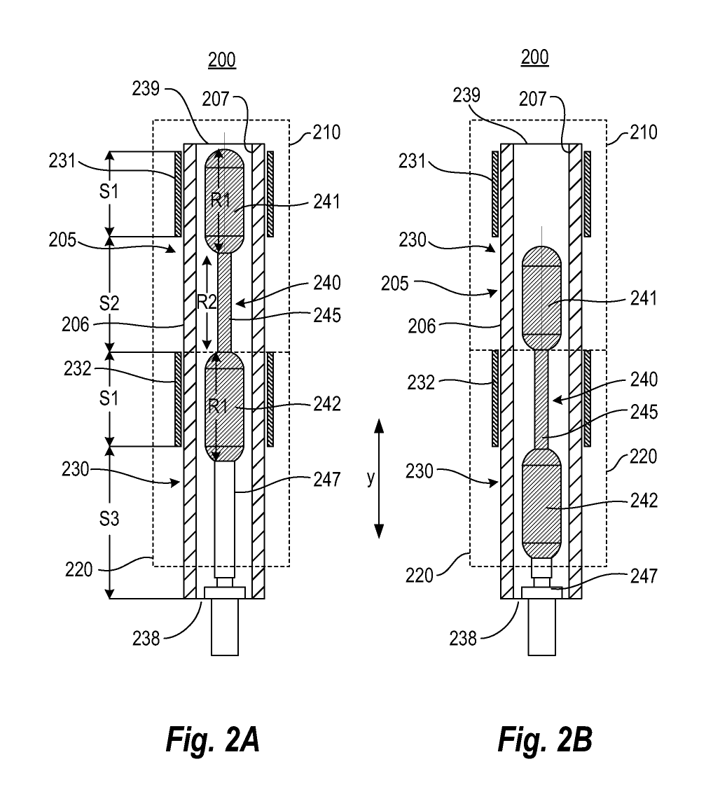

FIGS. 2A and 2B are simplified cross-sectional diagrams illustrating a variable capacitor device, according to a representative embodiment.

Referring to FIGS. 2A and 2B, variable capacitor device 200 includes first variable capacitor 210 and second variable capacitor 220 connected in series with one another, as discussed above. However, in the depicted embodiment, the variable capacitor device 200 has a housing 205, which may be formed of a dielectric or other electrically insulating material, examples of which are discussed above with respect to the substrate 135. The housing 205 may have a substantially cylindrical shape, for example, having a circular or elliptical cross-section. Of course the housing 205 may incorporate various other shapes and/or cross-sections without departing from the scope of the present teachings. The housing 205 includes a circumferential outer surface 206 and defines an inner cavity or bore 207.

A first stator band 231 corresponding to the first variable capacitor 210 and a second stator band 232 corresponding to the second variable capacitor 220 are formed around the circumferential outer surface 206 of the housing 205. The first and second stator bands 231 and 232 are formed of electrically conductive material, such as metal or metal alloy. For example, each of the first and second stator bands 231 and 232 may be formed of one or more of Mo, W, Cu, Al, Au, or the like. The housing 205, together with the first and second stator bands 231 and 232 thus form a stator 230. The first and second stator bands 231 and 232 each have a length S1, and are separated from one another by a first separating portion of the material of the housing 205 indicated by length S2. Further, the housing 205 has a proximal end 238 and a distal end 239 determined relative to an actuator (not shown). Thus, the second stator band 232 is separated from the proximal end 238 by a second separating portion of the material of the housing 205 indicated by length S3.

A rotor 240 is positioned within the bore 207 of the housing 205, and is configured to move axially (in the “y” direction). The rotor 240 includes first rotor plate 241, second rotor plate 242, connector rod 245 (in the “y” direction) and actuator rod 247. The first and second rotor plates 241 and 242 are formed of electrically conductive material, such as metal or metal alloy. For example, each of the first and second rotor plates 241 and 242 may be formed of one or more of Mo, W, Cu, Al, Au, or the like. Each of the first and second rotor plates 241 and 242 may likewise have a substantially cylindrical shape, for example, having a circular or elliptical cross-section. Of course the first and second rotor plates 241 and 242 may incorporate various other shapes and/or cross-sections, corresponding to the shape and/or cross-section of the housing 205 and bore 207, without departing from the scope of the present teachings. Also, each of the first and second rotor plates 241 and 242 have a length R1, which may be approximately the same as length S1, for example. Notably, the first and second rotor plates 241 and 242 may have rounded edges, as shown in FIGS. 2A and 2B. The rounded edges on the first and second rotor plates 241 and 242 reduce charge build up on these edges, which reduces arcing.

In the depicted embodiment, the first rotor plate 241 and the first stator band 231 form the first variable capacitor 210, where the position of the first rotor plate 241 relative to the first stator band 231 determines the value of a variable first capacitance. Likewise, the second rotor plate 242 and the second stator band 232 form the second variable capacitor 220, where the position of the second rotor plate 242 relative to the second stator band 232 determines the value of a variable second capacitance. The value of the total capacitance of the variable capacitor device 200 is effectively the product of the first and second capacitances divided by the sum of the first and second capacitances, as discussed above.

The connector rod 245 electrically and mechanically connects the first and second rotor plates 241 and 242 to one another at a fixed distance, indicated by a length R2. In an embodiment, the length R2 of the connector rod 245 may be substantially the same as the length S2 of the first separating portion of the housing 205. In this configuration, e.g., when the first and second stator bands have the length S1, the first and second rotor plates have the same length R1, and the length R2 is substantially equal to the length S2), the first and second variable capacitors 210 and 220 are about the same size, and the corresponding first and second capacitances are about equal for any particular position of the rotor 240 relative to the stator 230.

The connector rod 245 is formed of an electrically conductive material, and may be the same or different material as the first and second rotor plates 241 and 242. As discussed above with reference to the connector rod 145, the connector rod 245 has a narrower width (or diameter) than each of the first and second rotor plates 241 and 242. Accordingly, the connector rod 245 has minimal to no effect on the variable second capacitance, for example, when all or a portion of the connector rod 245 is aligned with the second stator band 232 (e.g., as shown in FIG. 2B). The variable capacitor device 200 is therefore able to provide a total variable capacitance that has a lower minimum value than that of conventional variable capacitor devices. In addition, the variable capacitor device 200 is able to provide multiple variable capacitors (e.g., first and second variable capacitors 210 and 220) connected in series, splitting the voltage on the variable capacitor device 200 among the multiple variable capacitors.

The actuator rod 247 is connected to the second rotor plate 242, at an opposite end to which the connector rod 245 is connected. The actuator rod 247 is formed of an electrically insulating material, such as ceramic, ultem, fiberglass, quartz, or other dielectric material, for example. The actuator rod 247 may have a narrower thickness or diameter than the first and second rotor plates 241 and 242, although the thickness or diameter of the actuator rod 247 has no effect on the total capacitance of the variable capacitor device 200 since it is formed of a non-conductive material.

The actuator rod 247 connects the rotor 240 to an actuator (not shown), which is configured to move the rotor 240 in axially (in the “y” direction) to obtain a desired capacitance by simultaneously adjusting the respective alignments of the first stator band 231 and the first rotor plate 241 of the first variable capacitor 210, and the second stator band 232 and the second rotor plate 242 of the second variable capacitor 220 of the second variable capacitor 220. The actuator may be any device capable of moving the rotor 240 in the axial direction, as discussed above. The rotor 240 is floating with respect to the stator 230, as discussed above.

In operation, the actuator rod 247 is configured to enable movement of the rotor 240 within the bore 207 of the housing 205 via operation of the actuator. The actuator rod 247 is able to move the rotor 240 to any position between (and including) the maximum capacitance position (as shown in FIG. 2A) and the minimum capacitance position (as shown in FIG. 2B).

As discussed above, at the maximum capacitance position, the first stator band 231 is substantially aligned with the first rotor plate 241, and the second stator band 232 is substantially aligned with the second rotor plate 242. Accordingly, each of the first and second capacitances is at its maximum value, because the relative sizes of the opposing plates of the first and second variable capacitors 210 and 220 are at their maximum values. The aggregate total capacitance of the variable capacitor device 200 is likewise at its maximum value.

At the minimum capacitance position, the first stator band 231 is minimally aligned (substantially unaligned) with the first rotor plate 241, and the second stator band 232 is minimally aligned (substantially unaligned) with the second rotor plate 242. Accordingly, each of the first and second capacitances is at its minimum value, because the opposing plates of the first and second variable capacitors 210 and 220 either do not overlap, or the relative sizes of the opposing plates of the first and second variable capacitors 210 and 220 are at their minimum values. Stated differently, at the minimum capacitance position, the first rotor plate 241 is substantially aligned with the first separating portion (indicated by the length S2) of the housing 205, and the second rotor plate 242 is substantially aligned with the second separating portion (indicated by the length S3) of the housing 205. The aggregate total capacitance of the variable capacitor device 200 is likewise at its minimum value.

The relative sizes (including lengths) of the first and second stator bands 231 and 232 and the first and second rotor plates 241 and 242 may be varied to provide unique benefits for any particular situation or to meet application specific requirements of various implementations. Similarly, the sizes (including lengths) of the first and second separating portions of the housing 205, indicated by the lengths S2 and S3, and the size of the connector rod 245 (including diameter and length), indicated by the length R2, may be varied to provide unique benefits for any particular situation or to meet application specific requirements of various implementations. Of course, other sizes and/or lengths may be incorporated without departing from the scope of the present teachings.

As mentioned above, voltage applied across the variable capacitor device 200 is divided between the first variable capacitor 210 and the second variable capacitor 220. That is, the voltage is split or shared by each end of the variable capacitor device 200. Accordingly, the variable capacitor device 200 is able to handle up to about twice the voltage of a conventional variable capacitor device (e.g., variable capacitor device 300) using the same size capacitors. Stated differently, the variable capacitor device 200 is able to handle the same voltage as a conventional variable capacitor device using first and second variable capacitors 210 and 220 of about half the size. For example, each of the first and second variable capacitors 210 and 220 may have a corresponding capacitance range of about 2 ρF to about 140 ρF. The corresponding capacitance range of the variable capacitor device 200 is therefore between about 1 ρF and about 70 ρF, while the voltage is split between the first and second variable capacitors 210 and 220, significantly increasing the withstanding voltage of the capacitor.

While specific embodiments are disclosed herein, many variations are possible, which remain within the concept and scope of the invention. Such variations would become clear after inspection of the specification, drawings and claims herein. The invention therefore is not to be restricted except within the scope of the appended claims.

What is claimed is:

1. A variable capacitor device, comprising:
a stator comprising a first stator plate and a second stator plate separated from the first stator plate by an electrically insulating material; and
a rotor comprising a first rotor plate and a second rotor plate connected by a rod, the rotor being configured to move axially for adjusting alignment of the first rotor plate relative to the first stator plate and the second rotor plate relative to the second stator plate, respectively,
wherein the first stator plate and the first rotor plate form a first variable capacitor, and the second stator plate and the second rotor plate form a second variable capacitor connected in series with the first variable capacitor, a first capacitance of the first variable capacitor and a second capacitance of the second variable capacitor being simultaneously adjustable upon the axial movement of the rotor to provide an adjustable total capacitance of the variable capacitor device.

2. The variable capacitor device of claim 1, wherein the rod connecting the first and second rotor plates comprises an electrically conductive material.

3. The variable capacitor device of claim 1, wherein a width of the rod connecting the first and second rotor plates is less than a width of each of the first and second rotor plates.

4. The variable capacitor device of claim 1, wherein the rotor is configured to move between a maximum capacitance position and a minimum capacitance position, wherein the first rotor plate is substantially aligned with the first stator plate and the second rotor plate is substantially aligned with the second stator plate when the rotor is in the maximum capacitance position.

5. The variable capacitor device of claim 4, wherein the first rotor plate is substantially unaligned with the first stator plate and the second rotor plate is substantially unaligned with the second stator plate when the rotor is in the minimum capacitance position.

6. The variable capacitor device of claim 1, further comprising:
an actuator connected to the second rotor plate via a actuator rod, the actuator being configured to axially move the rotor.

7. The variable capacitor device of claim 6, wherein the actuator comprises a screw actuator.

8. The variable capacitor device of claim 1, wherein the rotor is floating with respect to the stator.

9. The variable capacitor device of claim 1, wherein the each of the first and second rotor plates comprises rounded edges for reducing charge build up on the edges and for reducing arcing.

10. A variable capacitor device, comprising:
a housing formed of a dielectric material and defining a bore;
a stator comprising first and second stator bands formed around an outer surface of the housing, the first and second stator bands being separated by a first separating portion of the dielectric material of the housing; and
a rotor comprising first and second rotor plates, and a connector rod connecting the first and second rotor plates, wherein the rotor is configured to axially move within the bore of the housing between a maximum capacitance position, in which the first rotor plate is substantially aligned with the first stator band and the second rotor plate is substantially aligned with the second stator band, and a minimum capacitance position, in which the first rotor plate is substantially aligned with the first separating portion of the dielectric material.

11. The variable capacitor device of claim 10, wherein the rotor further comprises an actuator rod connected between the second rotor plate and an actuator, the actuator rod being configured to enable movement of the rotor within the bore of the housing via operation of the actuator.

12. The variable capacitor device of claim 11, wherein the stator has a proximal end relative to the actuator, the second stator band being separated from the proximal end of the stator by a second separating portion of the dielectric material, and
wherein the second rotor plate is substantially aligned with the second separating portion of the dielectric material when the rotor is in the minimum capacitance position.

13. The variable capacitor device of claim 11, wherein the connector rod comprises an electrically conductive material, and the actuator rod comprises an electrically insulating material.

14. The variable capacitor device of claim 10, wherein the housing is substantially cylindrical in shape.

15. The variable capacitor device of claim 10, wherein the dielectric material comprises one of polytetrafluoroethylene, glass or ceramic.

16. A capacitor device, comprising:
a first variable capacitor comprising first and second plates, the first plate being stationary and the second plate being movable with respect to the first plate to provide a variable first capacitance;
a second variable capacitor comprising third and fourth plates, the third plate being stationary and the fourth plate being movable with respect to the third plate to provide a variable second capacitance, the second variable capacitor being connected in series with the first variable capacitor;
a connector rod configured to connect the second and third plates at a fixed distance; and
an actuator rod configured to move the second and fourth plates simultaneously,
wherein a total capacitance of the capacitor device comprises a product of the first and second capacitances divided by a sum of the first and second capacitances, and
wherein a voltage applied across the capacitor device is divided between the first and second variable capacitors.

17. The capacitor device of claim 16, wherein the voltage applied across the capacitor device is balanced between the first variable capacitor and the second variable capacitor over an entire range of the total capacitance.

18. The capacitor device of claim 16, wherein the first capacitance is approximately equal to the second capacitance.

19. The capacitor device of claim 16, wherein the total capacitance has a maximum value when the first plate is substantially aligned with the second plate and the third plate is substantially aligned with the fourth plate via operation of the actuator rod.

20. The capacitor device of claim 16, wherein the total capacitance has a minimum value when the first plate is minimally aligned with the second plate and the third plate is minimally aligned with the fourth plate via operation of the actuator rod.
